(19) United States
(12) Patent Application Publication
(10) Pub. No.: US 2024/0340271 A1
(43) Pub. Date: Oct. 10, 2024

(54) TRANSPARENT AND KEY-LESS INSPECTION OF SSL/TLS-ENCRYPTED NETWORK TRAFFIC AND SOCKET ASSOCIATION USING EBPF

(71) Applicant: Threat X, Inc., Boston, MA (US)

(72) Inventor: Javier Rivera, Tampa, FL (US)

(21) Appl. No.: 18/615,765

(22) Filed: Mar. 25, 2024

Related U.S. Application Data
(60) Provisional application No. 63/457,477, filed on Apr. 6, 2023.

(51) Int. Cl. H04L 9/40

(52) U.S. Cl. CPC H04L 63/0428; H04L 63/166

(57) ABSTRACT

A computer-implemented system utilizes a traffic inspection subsystem (e.g., an extended Berkeley Packet Filter (eBPF) subsystem) to extract unencrypted data, before it has been encrypted or after it has been decrypted (e.g., by SSL/TLS), without the need for cryptographic key material from applications or processes. The system extracts the unencrypted data by attaching into the corresponding encryption libraries (e.g., SSL/TLS libraries) and their functions using the traffic inspection subsystem. The extracted unencrypted data is correlated to the corresponding network sockets that the encrypted traffic is using.

### BACKGROUND

SSL (Secure Sockets Layer) is the standard technology for keeping an internet connection secure and for safeguarding any sensitive data that is being sent between two systems, preventing unauthorized parties from reading and modifying any information transferred, including potential personal details. The two systems may, for example, be a server and a client (for example, a shopping website and a web browser) or a first server and a second server (for example, two email servers). SSL encrypts data in transit, thereby preventing hackers from reading it as it is sent over the connection.

TLS (Transport Layer Security) is an updated, more secure, version of SSL. Because both protocols are in widespread use, the term SSL/TLS is often used to refer to the use of SSL and/or TLS.

It is desirable to be able to inspect network flows that are encrypted, such as with SSL/TLS, for a variety of reasons. For example, SSL/TLS inspection can be used to detect and prevent security threats, such as malware, viruses, and unauthorized access. Such inspection allows security teams to analyze network traffic and identify suspicious activity that may be hidden within encrypted data. Another reason for performing SSL/TLS inspection is to assist in complying with strict regulatory requirements for data protection and privacy that exist in some industries. Yet another reason for performing SSL/TLS inspection is to optimize network performance by identifying and resolving performance issues, such as slow or unresponsive applications. By inspecting encrypted traffic, organizations can identify the root cause of performance issues and take steps to improve network performance.

Existing techniques for performing SSL/TLS inspection, however, have a variety of drawbacks. For example, some techniques require access to the root certificate authority (CA) (the certificate authority that generates the primary certificates for communication between the client and server). In many cases, it may be difficult or impossible to obtain access to the root CA. Other techniques rely on the extraction of the cryptographic key material, such as the session symmetric keys generated after the SSL/TLS handshake is completed, directly from the process memory space or libraries used. While this approach does not require access to the root CA, it relies on a separate set of processes and services to correlate the extracted keys to the encrypted network traffic for further inspection. This is not ideal in scenarios where inspection must be done in a real-time or near-real-time manner, such as detecting and blocking malicious traffic or sensitive data leakage prevention.

What is needed, therefore, are improved techniques for performing SSL/TLS inspection for network or socket-based connections.

### SUMMARY

A computer-implemented system utilizes a traffic inspection subsystem (e.g., an extended Berkeley Packet Filter (eBPF) subsystem) to extract unencrypted data, before it has been encrypted or after it has been decrypted (e.g., by SSL/TLS), without the need for cryptographic key material from applications or processes. The system extracts the unencrypted data by attaching into the corresponding encryption libraries (e.g., SSL/TLS libraries) and their functions using the traffic inspection subsystem. The extracted unencrypted data is correlated to the corresponding network sockets that the encrypted traffic is using.

Other features and advantages of various aspects and embodiments of the present invention will become apparent from the following description and from the claims.

### BRIEF DESCRIPTION OF THE DRAWINGS

FIG. 1 is a flowchart of a method for saving and deleting information about created and closed network connections according to one embodiment of the present invention.

FIG. 2 is a diagram of a system that performs the methods of FIGS. 1 and 3 according to one embodiment of the present invention.

FIG. 3 is a flowchart of a method for extracting unencrypted data before it has been encrypted by SSL/TLS and for correlating the extracted unencrypted data to the corresponding network sockets that the SSL/TLS-encrypted traffic is using according to one embodiment of the present invention.

### DETAILED DESCRIPTION

A computer-implemented system utilizes a traffic inspection subsystem (e.g., an extended Berkeley Packet Filter (eBPF) subsystem) to extract unencrypted data, before it has been encrypted or after it has been decrypted (e.g., by SSL/TLS), without the need for cryptographic key material from applications or processes. The system extracts the unencrypted data by attaching into the corresponding encryption libraries (e.g., SSL/TLS libraries) and their functions using the traffic inspection subsystem. The extracted unencrypted data is correlated to the corresponding network sockets that the encrypted traffic is using.

The system correlates the extracted unencrypted data to the corresponding network sockets that the encrypted traffic is using. Such correlation may be performed using kernel probes, such as other user and network system call probes, inside the hooked libraries.

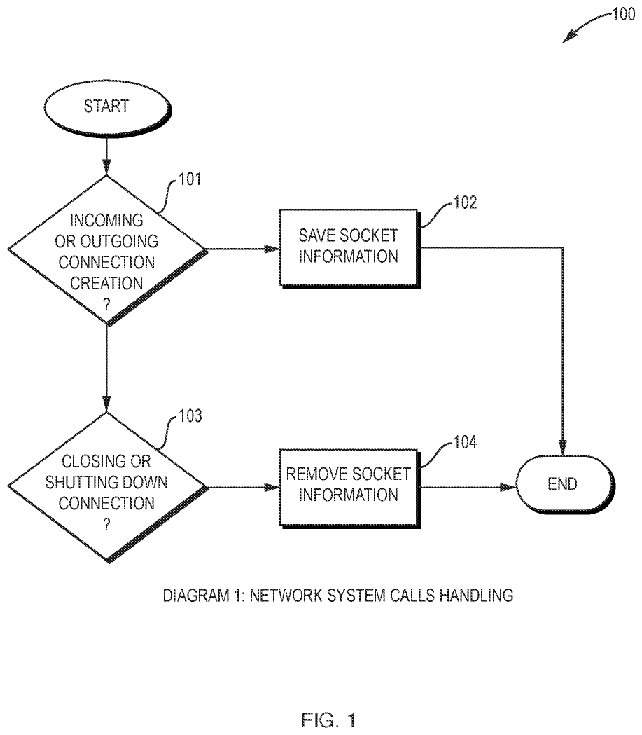

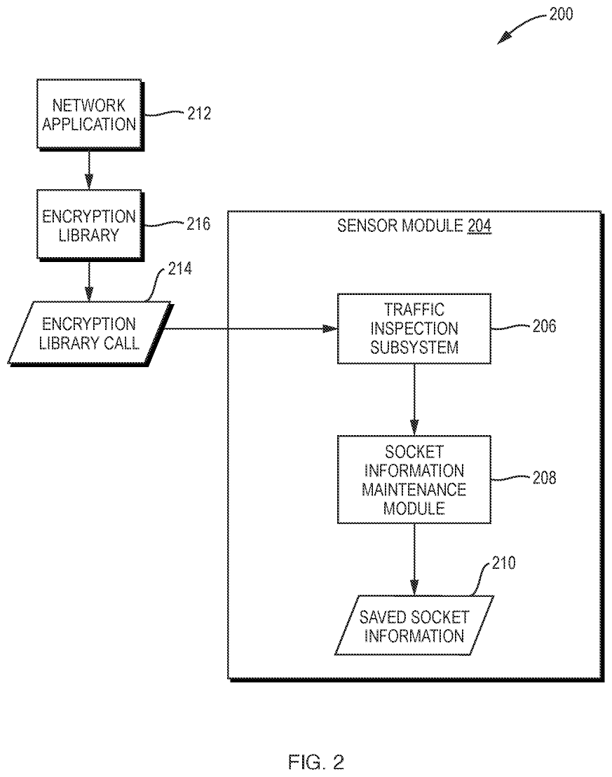

For example, referring to FIG. 1, a flowchart is shown of a method 100 for extracting unencrypted data before it has been encrypted (e.g., by SSL/TLS) and for correlating the extracted unencrypted data to the corresponding network sockets that the encrypted traffic is using according to one embodiment of the present invention. Referring to FIG. 2, a diagram is shown of a system 200 that performs the method 100 of FIG. 1 according to one embodiment of the present invention.

The system 200 includes a network application 212 and an encryption library 216. The encryption library 216 is an encryption library associated with one or more network communication protocols. For example, in some embodiments of the present invention, the encryption library 216 is or includes one or more SSL/TLS libraries.

The network application 212 makes a protocol library call 214 (e.g., an SSL/TLS library call) to one of the functions in the encryption library 216. Although FIG. 1 shows a single network application for ease of illustration, any of the techniques disclosed herein may be applied to any number of network applications, including a plurality of network applications of different types, in serial and/or in parallel. Similarly, although FIG. 1 shows a single protocol library call 214 for ease of illustration, any of the techniques disclosed herein may be applied to any number of library calls, including a plurality of library calls of different types (e.g., calls to different functions with the encryption library 216), in serial and/or in parallel.

The network application 212 may be any type of application, including, but not limited to, a web browser, an email client, a file transfer application, a Voice over Internet Protocol (VoIP) application, a streaming media application, an online gaming application, or a remote access application (e.g., a Remote Desktop or Virtual Private Network (VPN) client).

The system 200 also includes a sensor module 204. The sensor module 204 may, for example, be implemented in software, which may execute on the same computer as the network application 212 and/or the encryption library 216.

As will be described in more detail below, the sensor module 204 intercepts calls to functions in the encryption library 216 in order to:
extract unencrypted data from decryption and encryption functions without cryptographic material knowledge (e.g., without need for asymmetric or symmetric keys);
extract socket file descriptors and Internet Protocol (IP) information from network system calls;
associate socket information extracted from the network system calls to sessions or connections (e.g., SSL/TLS sessions or connections); and
categorize encrypted traffic flows as ingress flows or egress flows.

Returning to FIG. 2, the sensor module 204 receives the protocol library call 214. The sensor module 204 may receive the protocol library call 214 even if the network application 212 does not address or otherwise target the sensor module 204 with the protocol library call 214. In fact, the network application 212 may issue the protocol library call 214 in a conventional manner (e.g., in the same way as if the system 200 did not include the sensor module 204), and the process of including the sensor module 204 in the system 200 need not require or involve making any modifications to the network application 212.

The sensor module 204 may receive the IP network flow 202 in any of a variety of ways. For example, the sensor module 204 may include one or more traffic inspection subsystems 206. The traffic inspection subsystem 206 may, for example, use one or more extended Berkeley packet filter (eBPF) subsystems 206 to perform any of the functions disclosed herein. (Although the term “traffic inspection subsystem 206” is used to refer to element 206 herein, element 206 may include one or more traffic inspection subsystems.) The sensor module 204 may use the traffic inspection subsystem 206 to monitor and receive any library calls 214 that are made by the network application 212 to the encryption library 216.

The extended Berkeley packet filter (eBPF) is a virtual machine-based technology with origins in the Linux kernel that allows for the efficient and flexible processing of network packets and other types of data. The eBPF virtual machine runs sandboxed programs in a privileged context, such as the operating system kernel, where they can be used to inspect and modify network packets as they pass through the system 200. This allows for real-time monitoring and analysis of network traffic, without the need for additional software or hardware, and without requiring changes to kernel source code or loading of additional kernel modules.

eBPF programs can be attached to a variety of kernel events, such as network packets arriving or leaving the system 200, system calls made by applications within the system 200, and kernel function calls. When an event occurs, the eBPF program is executed, and it can inspect or modify the data associated with the event.

One of the key benefits of eBPF is its performance. eBPF drastically improves processing by being JIT-compiled and running directly in the kernel. Because eBPF programs run within the kernel, they have access to the full power of the system 200's hardware, including multiple CPU cores and specialized hardware features. This allows for high-performance packet processing and real-time analysis of network traffic.

Furthermore, eBPF programs are verified to not crash the kernel and can only be modified by privileged users. Use of eBPF makes it possible to modify and add functionality and use cases to the kernel without having to restart or patch it.

eBPF, however, is merely one example of a technology that may be used to perform the functions disclosed herein, and embodiments of the present invention are not limited to using eBPF to perform such functions. As one example of another technology that may be used to perform various functions disclosed herein, kernel modules may be used to implement at least some of the functionality of the traffic inspection subsystem 206. As another example, at least some of the functionality of the traffic inspection subsystem 206 may be implemented using one or more tracing programs, such as one or more of strace, ltrace, and ftrace.

Returning to FIG. 2, the sensor module 204 may use the traffic inspection subsystem 206 to attach to one or more functions in the encryption library 216. Once the sensor module 204 has been deployed and is attached to the encryption library 216, the sensor module 204 may use the traffic inspection subsystem 206 to monitor calls to functions in the encryption library 216, such as the protocol library call 214. As a result, whenever a call (such as the protocol library call 214) is made to the encryption library 216, the traffic inspection subsystem 206 in the sensor module 204 may receive (intercept) that call before the call is received and processed by the encryption library 216 itself.

The sensor module 204 also includes a socket information maintenance module 208. As will be described in more detail below, the socket information maintenance module 208 stores, updates, and deletes various saved socket information 210 about one or more network sockets 210 over time.

More specifically, and referring to FIG. 1, when the traffic inspection subsystem 206 in the sensor module 204 receives the protocol library call 214, the socket information maintenance module 208 in the sensor module 204 determines whether the protocol library call 214 is a call to a function for creating an incoming or outgoing network connection (FIG. 1, operation 101). If the protocol library call 214 is determined to be a call to a function for creating an incoming or outgoing network connection, then the socket information maintenance module 208 stores the socket information for the connection being created within the saved socket information 210 (FIG. 1, operation 102). Such information may include, for example, the type of socket (network, UNIX, etc.) and related metadata (e.g., for network connections, IP addresses and ports). The saved socket information 210 may contain socket information not only for the protocol library call 214, but also for any other library calls for network connections whose creation calls were previously intercepted by the sensor module 204, and which have not yet been closed.

Furthermore, although the disclosure herein refers to network connections, embodiments of the present invention are applicable not only to network connections, but more generally to any kind of socket, whether or not that socket is associated with a network connection. Examples of such non-network sockets include sockets that are used for inter-process communication (IPC) within a single system and which do not involve network communication. For example, embodiments of the present invention are applicable to domain sockets, pipe sockets, and message queues. As a result, any description herein of network connections and of techniques that are applied to network connections should be understood to be more generally applicable to sockets which are not associated with network connections.

If the protocol library call 214 is determined not to be a call to a function for creating an incoming or outgoing network connection, then the socket information maintenance module 208 determines whether the protocol library call 214 is a call to a function for closing an existing incoming or outgoing network connection (FIG. 1, operation 103). If the protocol library call 214 is determined to be a call to a function for closing an existing incoming or outgoing network connection, then the socket information maintenance module 208 removes the previously-saved connection information for that connection from the saved socket information 210 (FIG. 1, operation 104).

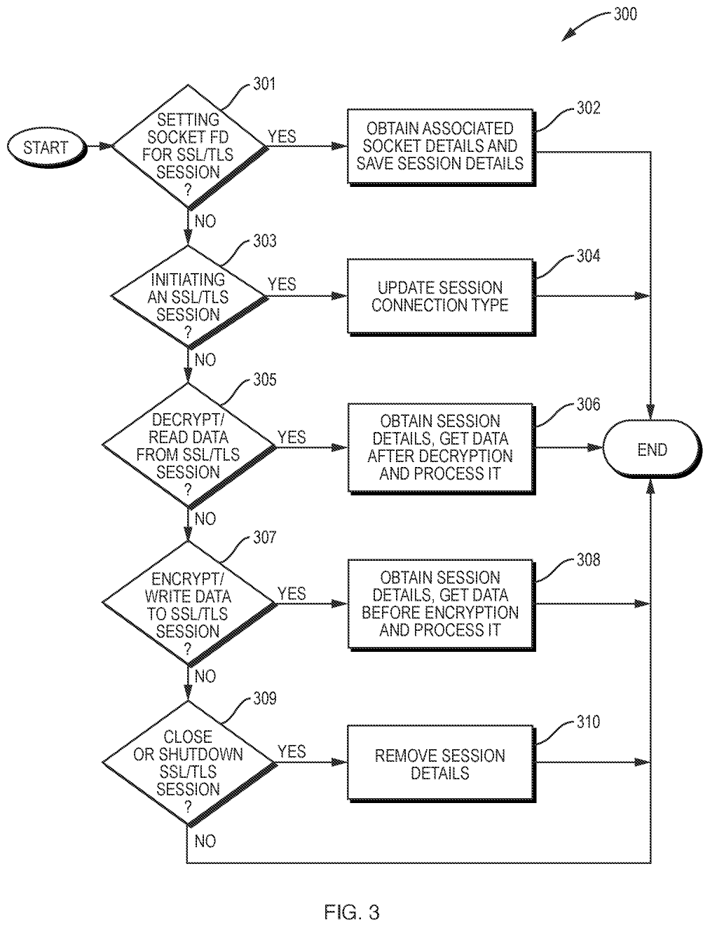

Referring to FIG. 3, a flowchart is shown of a method 300 for extracting unencrypted data before it has been encrypted by SSL/TLS and for correlating the extracted unencrypted data to the corresponding network sockets that the SSL/TLS-encrypted traffic is using according to one embodiment of the present invention. More specifically, FIG. 3 illustrates how the method 300 how the traffic inspection subsystem 206 analyzes SSL/TLS events in the SSL/TLS library in order to determine which socket connection details are associated to a SSL/TLS session or connection. The system 200 of FIG. 2 may perform the method 300 of FIG. 3 according to one embodiment of the present invention.

Although the method 300 of FIG. 3 is shown in connection with SSL/TLS, this is merely an example and does not constitute a limitation of the present invention. Alternatively, embodiments of the method 300 may be implemented and performed in connection with protocols other than SSL/TLS. As a result, any reference to SSL/TLS in FIG. 3 and in the description herein of the method 300 should be understood to be equally applicable to any other suitable protocol(s).

When the sensor module 204 receives an SSL/TLS library call (e.g., another instance of the protocol library call 214, after the instance of the protocol library call 214 which creates a network connection), the traffic inspection subsystem 206 may intercept that library call in any of the ways disclosed herein. The socket information maintenance module 208 may examine the protocol library call 214 to determine what type of library call it is and:
If the protocol library call 214 aims to set a socket file descriptor for a SSL/TLS session, then the sensor module 204 may obtain the socket details associated to that file descriptor and correlate them to the SSL/TLS session by hooking into the functions that set the file descriptor for a given SSL/TLS context (FIG. 3, operation 301), and retrieve the associated socket details from the saved socket information 210 and create a new SSL/TLS session (FIG. 3, operation 302).
If the protocol library call 214 aims to initialize an encrypted session as an incoming (e.g., server) or outgoing (e.g., client) connection, then the sensor module 204 may update the corresponding SSL/TLS session and the saved socket information 210 in order to update the corresponding SSL/TLS session (FIG. 3, operation 303) with the corresponding connection type (FIG. 3, operation 304).
If the protocol library call 214 aims to decrypt incoming data, then the sensor module 204 may retrieve the corresponding SSL/TLS session details based on the SSL context being passed to the read/decrypt function in the encryption library 216, and process the data (FIG. 3, operation 305), and retrieve the socket details for the corresponding SSL/TLS session from the saved socket information 210 (previously created in operation 302 and updated in operation 304), capture the decrypted data from the output of the read/decrypt function when that function completes the decryption, and correlate the unencrypted data to the retrieved SSL/TLS session details (FIG. 3, operation 306). The resulting corresponding TLS session data, socket details, and unencrypted data may be processed by the sensor module 204 in any of a variety of ways.
If the protocol library call 214 aims to encrypt outgoing data, then the sensor module 204 may retrieve the corresponding SSL/TLS session details based on the SSL context being passed to the write/encrypt function in the encryption library 216, and process the data (FIG. 3, operation 307), and retrieve the socket details for the corresponding SSL/TLS session (previously created in operation 302 and updated in operation 304), capture the unencrypted data from the input of the write/encrypt function and correlate the unencrypted data to the retrieved SSL/TLS session details before the unencrypted data goes through the encryption process performed by the write/encrypt function in the encryption library 216 (FIG. 3, operation 308). The resulting TLS session data, socket details, and unencrypted data may be processed by the sensor module 204 in any of a variety of ways.
If the protocol library call 214 aims to close or shutdown an SSL/TLS session, then the sensor module 204 may remove previously saved session and socket details for the corresponding session from the saved socket information 210 (FIG. 3, operation 309) and remove the session details and process termination details from the saved socket information (FIG. 3, operation 310).

In any of the above examples, the sensor module 204 may gather and store a variety of information into an “event,” which may be used for subsequent processing by the sensor module 204 in any of a variety of ways. Such an event may, for example, include TLS session data, socket details, an event type, and data.

The TLS session data in any event may include, for example, the type of session (e.g., client or server). Such information may help the sensor module 204 to determine the initiator of a connection, which may be used to determine which kind of analysis needs to be performed. For example, if the session type is SERVER, then incoming data may be treated as requests and outgoing data may be treated as responses on an HTTP server (and vice versa if the session type is CLIENT).

The socket details in an event may include, for example, the remote address, device, or file in the socket. This may, for example, be a client's remote IP address and its corresponding port, network transport layer information (e.g., TCP or UDP), the process that it belongs to, and/or the file descriptor number.

The type of an event may, for example, be “read” or “write.” This may help to determine the direction of the data being read without having access to the network flow directly. Incoming data to the application may be read or decrypted, whereas outgoing data may be written or encrypted.

The data in an event may, for example, be unencrypted data produced as output by a read/unencrypt function in the encryption library 216, or unencrypted data provided as input to a write/encrypt function in the encryption library 216.

The system 200 of FIG. 2 is illustrated in terms of functional modules and their respective inputs and outputs. The functions performed by the system 200 of FIG. 2 may be implemented in any of a variety of ways. For example, any particular module shown in FIG. 2 may be implemented in one or a plurality of modules. Such a plurality of modules may, for example, be implemented on a single device (e.g., computer) or be distributed across a plurality of devices. As merely one example of this, the network application 212, sensor module 204, and encryption library 216 may be implemented on a single computer.

Although certain functions are disclosed as being performed in kernel space using eBPF, some of the data disclosed herein may be passed to user space, and some of the functions disclosed herein may be performed on such data in user space, to avoid restrictions associated with eBPF programs that execute in kernel space.

Benefits of embodiments of the present invention include the following.

Embodiments of the present invention may be used to inspect network flows that are encrypted, such as with SSL/TLS, by inspecting such flows before they have been encrypted and/or after they have been decrypted. Inspecting such network flows can be useful for a variety of purposes, such as to detect and prevent security threats, such as malware, viruses, and unauthorized access; to allow security teams to analyze network traffic and identify suspicious activity that may be hidden within encrypted data; to assist in complying with strict regulatory requirements for data protection and privacy that exist in some industries; and to optimize network performance by identifying and resolving performance issues, such as slow or unresponsive applications. By inspecting encrypted traffic, embodiments of the present invention may be used to identify the root cause of performance issues and take steps to improve network performance.

As previously mentioned, some existing techniques for performing SSL/TLS inspection require access to the root certificate authority (CA) (the certificate authority that generates the primary certificates for communication between the client and server). In many cases, however, it may be difficult or impossible to obtain access to the root CA, thereby making it impossible to apply techniques that require access to the root CA. Embodiments of the present invention may overcome this problem by extracting unencrypted data directly from the network protocol libraries (e.g., the SSL/TLS libraries) before the data is encrypted or after it has been decrypted. This process is facilitated by the traffic inspection subsystem 206, such as an extended Berkeley Packet Filter (eBPF) subsystem, which attaches to the functions within the encryption library 216. Embodiments of the present invention extract unencrypted data without requiring cryptographic key material from applications or processes. As a result, such embodiments do not need the private keys or certificates that would typically be required to decrypt the data manually. In this way, embodiments of the present invention overcome the problems faced by existing techniques that require access to the root CA.

As further described above, other existing techniques rely on the extraction of the cryptographic key material, such as the session symmetric keys generated after the SSL/TLS handshake is completed, directly from the process memory space or libraries used. While this approach does not require access to the root CA, it relies on a separate set of processes and services to correlate the extracted keys to the encrypted network traffic for further inspection. This is not ideal in scenarios where inspection must be done in a real-time or near-real-time manner, such as detecting and blocking malicious traffic or sensitive data leakage prevention. Embodiments of the present invention overcome the problems of such systems by implementing a different approach that does not require access to cryptographic keys at all. Instead, embodiments of the present invention inspect the data before encryption and/or after decryption by integrating with the network protocol libraries (e.g., SSL/TLS libraries) using a traffic inspection subsystem, such as an extended Berkeley Packet Filter (eBPF) subsystem. By bypassing the need to handle cryptographic keys, embodiments of the present invention avoid the problems of systems which rely on the use of such keys, and may be used effectively even in in scenarios where inspection must be done in a real-time or near-real-time manner, such as to detect and block malicious traffic or to prevent sensitive data leaks.

Embodiments of the present invention include a variety of novel features and advantages. For example, embodiments of the present invention are able to correlate network-layer information to session-layer and application-layer data in a single sensor. In contrast, some prior systems perform network-to-encrypted-data correlation using out-of-band correlation. More specifically, such systems save/extract the keys or certificates, capture encrypted traffic and decrypt it with tools such as Wireshark. Although this can be useful for after-the-fact forensic analysis, it is not useful for the kind of real-time (or near real-time) detection/prevention that can be accomplished by embodiments of the present invention.

Some prior systems hook into the SSL/TLS read and write calls, but are not able to obtain information about the sockets. Therefore, while inspection is transparent in such cases, such systems are not able to correlate to the network or socket traffic, unlike embodiments of the present invention.

Yet other prior systems classify network traffic as SSL/TLS connections, but do not perform inspection inline. Instead, such systems still rely on capturing the keys or having the certificates required for offline/out-of-band decryption. In contrast, embodiments of the present invention may perform the functions disclosed herein without requiring such keys or certificates.

Embodiments of the present invention are also able to determine the direction of traffic flow (ingress vs. egress) for encrypted sessions. Being able to determine the direction of traffic flow can provide a variety of benefits, such as the following. By identifying the direction of traffic flow, network administrators can better monitor and protect against potential threats such as malware, unauthorized access, or data exfiltration. For example, if a network administrator notices a large amount of encrypted traffic leaving their network, they may investigate to determine whether there is an unauthorized data leak. Identifying the direction of traffic flow can also be helpful when troubleshooting network issues. For example, if there are latency or performance issues, knowing whether the issue is with ingress or egress traffic can help narrow down the root cause and speed up the resolution process. As yet another example, by analyzing the direction of traffic flow, network administrators can better plan for capacity requirements. For example, if a network sees a significant amount of egress traffic, it may indicate that more bandwidth is needed to support outgoing data transfers.

Embodiments of the present invention are also able to perform transparent extraction of data from encrypted connections with zero knowledge of the cryptographic material. This makes such embodiments easier to deploy and more generally applicable than techniques which require knowledge of the cryptographic material, which is not always available.

Embodiments of the present invention do not require any additional services to decrypt encrypted data. Such embodiments are simpler to deploy and also do not incur the overhead and potential performance degradation of solutions which require deployment of additional services.

In some embodiments, the techniques described herein relate to a method performed by at least one computer processor executing computer program instructions stored on at least one non-transitory computer-readable medium, the method including: (A) intercepting a first call to a function in an encryption library, for creating a network entity according to a network protocol; (B) extracting unencrypted data from the first call; (C) correlating the extracted unencrypted data from the first call with information about a socket associated with the created network entity.

The network entity may include a context, a session, and/or a connection.

Operation (B) may include extracting the unencrypted data from the first call before the encrypted data is encrypted to generate encrypted data.

Operation (B) may include extracting the unencrypted data from the first call after encrypted data has been decrypted to generate the encrypted data.

The network protocol may be SSL/TLS.

Intercepting the first call may include intercepting the first call using an extended Berkeley packet filter (eBPF) subsystem.

Extracting the unencrypted data from the first call may include extracting the unencrypted data from the first call using an extended Berkeley packet filter (eBPF) subsystem.

The method may further include: (D) intercepting a second call to a function other than a function in the encryption library that does not create a network entity; and (E) extracting unencrypted data from the second call; (F) correlating the extracted unencrypted data from the second call with information about the socket associated with the created network entity.

Intercepting the second call may include intercepting the second call using an extended Berkeley packet filter (eBPF) subsystem.

Extracting the unencrypted data from the second call may include extracting the unencrypted data from the second call using an extended Berkeley packet filter (eBPF) subsystem.

In some embodiments, the techniques described herein relate to a system including at least one non-transitory computer-readable medium having computer program instructions stored thereon, the computer program instructions being executable by at least one computer processor to perform a method, the method including: (A) intercepting a first call to a function in an encryption library, for creating a network entity according to a network protocol; (B) extracting unencrypted data from the first call; (C) correlating the extracted unencrypted data from the first call with information about a socket associated with the created network entity.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically receive (e.g., intercept) telecommunications network traffic. Such functions are inherently rooted in computer technology and constitute an improvement to computer technology, and could not be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored on at least one non-transitory computer-readable medium, the method comprising:
(A) intercepting a first call to a function in an encryption library, for creating a network entity according to a network protocol;
(B) extracting unencrypted data from the first call;
(C) correlating the extracted unencrypted data from the first call with information about a socket associated with the created network entity.

2. The method of claim 1, wherein the network entity comprises a context.

3. The method of claim 1, wherein the network entity comprises a session.

4. The method of claim 1, wherein the network entity comprises a connection.

5. The method of claim 1, wherein (B) comprises extracting the unencrypted data from the first call before the encrypted data is encrypted to generate encrypted data.

6. The method of claim 1, wherein (B) comprises extracting the unencrypted data from the first call after encrypted data has been decrypted to generate the encrypted data.

7. The method of claim 1, wherein the network protocol comprises SSL/TLS.

8. The method of claim 1, wherein intercepting the first call comprises intercepting the first call using an extended Berkeley packet filter (eBPF) subsystem.

9. The method of claim 1, wherein extracting the unencrypted data from the first call comprises extracting the unencrypted data from the first call using an extended Berkeley packet filter (eBPF) subsystem.

10. The method of claim 1, further comprising:
(D) intercepting a second call to a function other than a function in the encryption library that does not create a network entity; and
(E) extracting unencrypted data from the second call;
(F) correlating the extracted unencrypted data from the second call with information about the socket associated with the created network entity.

11. The method of claim 10, wherein intercepting the second call comprises intercepting the second call using an extended Berkeley packet filter (eBPF) subsystem.

12. The method of claim 10, wherein extracting the unencrypted data from the second call comprises extracting the unencrypted data from the second call using an extended Berkeley packet filter (eBPF) subsystem.

13. A system comprising at least one non-transitory computer-readable medium having computer program instructions stored thereon, the computer program instructions being executable by at least one computer processor to perform a method, the method comprising:
(A) intercepting a first call to a function in an encryption library, for creating a network entity according to a network protocol;
(B) extracting unencrypted data from the first call;
(C) correlating the extracted unencrypted data from the first call with information about a socket associated with the created network entity.

14. The system of claim 13, wherein the network entity comprises a context.

15. The system of claim 13, wherein the network entity comprises a session.

16. The system of claim 13, wherein the network entity comprises a connection.

17. The system of claim 13, wherein (B) comprises extracting the unencrypted data from the first call before the encrypted data is encrypted to generate encrypted data.

18. The system of claim 13, wherein (B) comprises extracting the unencrypted data from the first call after encrypted data has been decrypted to generate the encrypted data.

19. The system of claim 13, wherein the network protocol comprises SSL/TLS.

20. The system of claim 13, wherein intercepting the first call comprises intercepting the first call using an extended Berkeley packet filter (eBPF) subsystem.

21. The system of claim 13, wherein extracting the unencrypted data from the first call comprises extracting the unencrypted data from the first call using an extended Berkeley packet filter (eBPF) subsystem.

22. The system of claim 13, wherein the method further comprises:
(D) intercepting a second call to a function other than a function in the encryption library that does not create a network entity; and
(E) extracting unencrypted data from the second call;
(F) correlating the extracted unencrypted data from the second call with information about the socket associated with the created network entity.

23. The system of claim 22, wherein intercepting the second call comprises intercepting the second call using an extended Berkeley packet filter (eBPF) subsystem.

24. The system of claim 22, wherein extracting the unencrypted data from the second call comprises extracting the unencrypted data from the second call using an extended Berkeley packet filter (eBPF) subsystem.
